(19) United States
(12) Patent Application Publication
(10) Pub. No.: US 2016/0333793 A1
(43) Pub. Date: Nov. 17, 2016

(54) ACCESSORY GEARBOX ASSEMBLY FOR AN AIRCRAFT TURBINE ENGINE

(71) Applicant: HISPANO - SUIZA, Colombes (FR)

(72) Inventors: Stephane PRUNERA-USACH, Jurancon (FR); Julien VIEL, Argenteuil (FR)

(73) Assignee: Hispano - Suiza, Colombes (FR)

(21) Appl. No.: 15/111,785

(22) PCT Filed: Jan. 16, 2015
(86) PCT No.: PCT/FR2015/050115

§ 371 Date: Jul. 14, 2016

(30) Foreign Application Priority Data
Jan. 16, 2014 (FR) 1450351

(51) Int. Cl. F02C 7/32; F02C 3/04

(52) U.S. Cl. CPC F02C 7/32; F02C 3/04; F05D 2260/4031

(57) ABSTRACT

The invention relates to an accessory gearbox assembly for an aircraft turbine engine including: —a radial drive shaft (41); —an input gearbox (20) including an input gear, attachable onto a drive shaft (12) connecting a turbine (11) to a compressor (10) of the turbine engine, and an output gear secured to the radial drive shaft (41); —an accessory (51) including a stator, attachable to a housing (2) of the turbine engine, and a rotor that is rotatably mounted relative to the stator; and —a transfer gearbox (41) including an input gear, rotatably secured to the radial drive shaft (41), and an output gear rotatably secured to the rotor of the accessory (51). The input gear (45) engages with the output gear (46) so that, when the drive shaft (12) is rotated, the drive shaft rotates the rotor of the accessory (51) via the input gearbox (20), the radial drive shaft (41), and the transfer gearbox (41).

### FIELD OF THE INVENTION

The invention relates to an accessory drive assembly for aircraft turbine engines, and an associated turbine engine.

### PRIOR ART

Turbine engines generally comprise one or more rotating spools. Each rotating spool comprises a compressor, a turbine and an engine shaft connecting the turbine to the compressor to drive the compressor in rotation. In turbojets that comprise several spools, the compressor shafts of the different spools extend concentrically around one another.

A portion of the power generated by the turbojet is used to drive different accessories (or auxiliary machines) needed for the operation of the turbojet or of the aircraft, such as an electrical generator, a lubricant pump or a fuel pump for example.

To this end, the turbojet generally comprises an inlet gearbox, a radial drive shaft extending inside a radial arm of the inter-compressor casing, a transfer gearbox and an accessory gearbox supporting the different accessories.

When the engine shaft is driven in rotation, it drives mechanically the different accessories through the inlet gearbox (IGB), the radial drive shaft, the transfer gearbox (TGB) and the accessory gearbox (AGB). The inlet gear box and the transfer gear box provide an angle drive. The accessory gear box transmits the rotation movement to the different accessories.

The assembly formed by the accessory gear box and the accessories is generally housed inside the casing of the turbine engine, in proximity to the fan, in a zone called the “fan zone.”

To reduce the space requirement of this assembly, housing the auxiliary unit between the high-pressure spool and the inner fixed structure of the turbine engine can also be contemplated. This would, however, necessitate adapting the accessory gear box to the space available in this zone and reducing the volume occupied by the box and the accessories.

### SUMMARY OF THE INVENTION

One aim of the invention is to propose a configuration allowing adaptation of the bulk of the accessory gearbox and/or the accessories to the space available in the zone between the high-pressure spool and the inner fixed structure.

This aim is achieved within the scope of the present invention thanks to an accessory drive assembly for an aircraft turbine engine comprising:
a radial drive shaft (RDS),
an inlet gearbox (IGB) comprising an input gear suitable to be attached to a transmission shaft connecting a turbine to a compressor of the turbine engine, and an output gear fixed to the radial drive shaft,
an accessory comprising a stator suitable to be attached to a casing of the turbine engine, and a rotor rotatably mounted with respect to the stator,
a transfer gearbox (TGB) comprising an input gear fixed in rotation with the radial drive shaft, and an output gear fixed in rotation with the rotor of the accessory, the input gear meshing with the output gear so that when the transmission shaft is driven in rotation, the transmission shaft drives the rotor of the accessory in rotation via the inlet gearbox, the radial drive shaft and the transfer gearbox.

In the proposed drive assembly, the accessory is connected to the output of the transfer gearbox. The accessory is therefore not connected to an accessory gearbox.

The drive assembly can also be designed so that the rotor of the accessory has an axis of rotation which extends substantially parallel to the engine casing of the turbine engine, in a substantially longitudinal direction of the turbine engine.

Moreover, the accessory drive assembly can comprise several radial drive shafts and several accessories distributed around the engine casing of the turbine engine, each accessory being driven via a respective radial drive shaft.

The drive assembly can have the following features:
the input gear and the output gear of the transfer gearbox form an angle drive,
the transfer gearbox is designed to be housed in an inter compressor casing of the turbine engine,
the accessory is a fuel pump, an electrical generator, a lubricant pump, a hydraulic pump, a starter, a constant speed drive (CSD), a tachometer, or any other accessory necessary for the operation of the turbine engine or the aircraft,
the inlet gearbox comprises several output gears meshing with the input gear, and the accessory drive assembly comprises several radial drive shafts and several pieces of equipment, each radial drive shaft connecting an output gear of the inlet gearbox with a respective piece of equipment to be driven, one of the pieces of equipment being the accessory,
one of the pieces of equipment is an accessory gearbox (AGB) supporting one or more accessory(ies),
the pieces of equipment are positioned around the engine casing of the turbine engine,
the assembly comprises an additional accessory, the additional accessory comprising a stator attached to the casing of the turbine engine or to the stator of the accessory, and a rotor rotatably mounted with respect to the stator, the rotor of the additional accessory being connected to the rotor of the accessory, so that the rotor of the additional accessory is driven in rotation by the rotor of the accessory,
the accessory and/or the pieces of equipment is (are) positioned in a first zone located between a primary airflow and a secondary airflow of the turbine engine,
the accessory drive assembly also comprises an accessory or piece of equipment positioned in a second zone located upstream of the first zone in the circulation direction of the airflows.

The invention also relates to a turbine engine for an aircraft comprising:
a turbine,
a compressor,
an engine shaft connecting the turbine to the compressor so that the turbine drives the compressor,
an accessory drive assembly as defined previously.

The turbine engine can comprise an engine casing in which are housed the turbine, the compressor and the compressor shaft, the accessory(ies) extending around the engine casing.

### PRESENTATION OF THE DRAWINGS

Other features and advantages will be revealed in the description that follows, which is purely illustrative and not limiting and must be read with reference to the appended figures, among which:

FIG. 1 shows schematically in section an example of a turbine engine comprising an accessory drive assembly conforming to a first embodiment of the invention,

FIGS. 2 to 4 show schematically in perspective, in side view and in front view an accessory drive assembly conforming to the first embodiment of the invention,

FIG. 5 shows schematically in longitudinal section an example of a turbine engine comprising an accessory drive assembly conforming to a second embodiment of the invention,

FIG. 6 shows schematically and in perspective an accessory drive assembly conforming to the second embodiment of the invention.

### DETAILED DESCRIPTION OF ONE EMBODIMENT

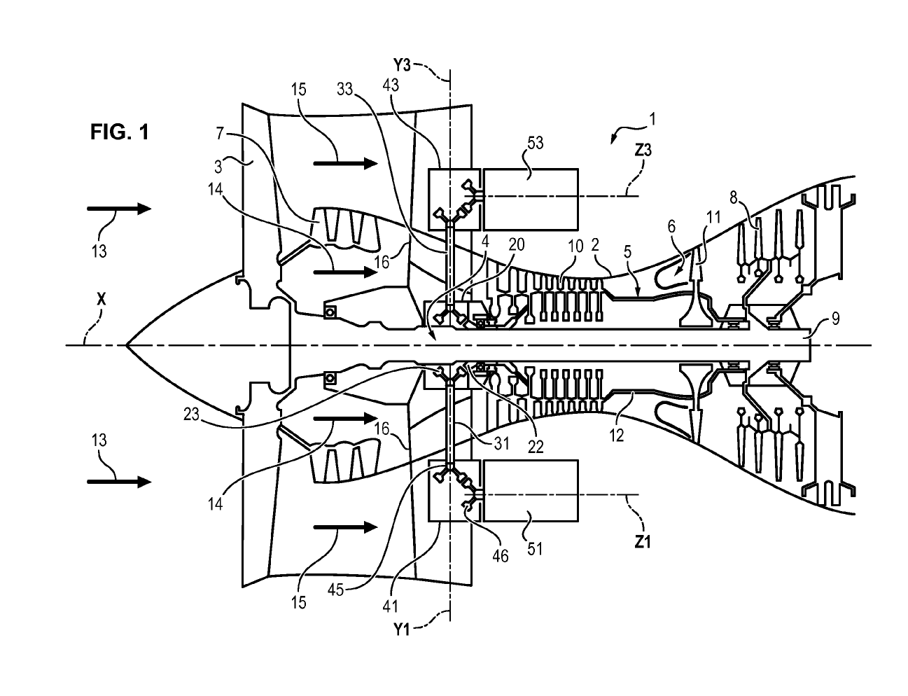

In FIG. 1, the turbine engine 1 shown is a two-spool turbine engine. The turbine engine 1 comprises an engine casing 2, a fan 3, a low-pressure spool 4, a high-pressure spool 5 and a combustion chamber 6.

The low-pressure spool 4 comprises a low-pressure compressor 7, a low-pressure turbine 8 and a low-pressure transmission shaft 9 connecting the low-pressure compressor 7 to the low-pressure turbine 8. The low-pressure transmission shaft 9 extends along a longitudinal axis X of the turbojet 1. The low-pressure turbine 8 is suitable for driving in rotation the low-pressure compressor 7 via the low-pressure transmission shaft 9. The entire low-pressure spool 4 is thus driven in rotation around the axis X with respect to the engine casing 2.

The high-pressure spool 5 comprises a high-pressure compressor 10, a high-pressure turbine 11 and a high-pressure transmission shaft 12 connecting the high-pressure compressor 10 to the high-pressure turbine 11. The high-pressure transmission shaft 12 extends around the low pressure transmission shaft 9, concentrically with it (in other words, centered on the axis X). The high-pressure turbine 11 is suitable for driving in rotation the high-pressure compressor 10 via the high-pressure transmission shaft 12. The entire high-pressure spool 5 is thus driven in rotation around the axis X with respect to the casing 2.

The turbine engine also comprises an inter-compressor casing 16 extending between the low-pressure compressor 7 and the high-pressure compressor 10.

In operation, the low-pressure 4 and high-pressure 5 spools are driven in rotation with respect to the casing 2 independently of one another. Thus, the low-pressure transmission shaft 9 and the high-pressure transmission shaft 12 are driven in rotation independently of one another around the longitudinal axis X of the turbojet 1.

When the turbojet 1 is operating, the air 13 is aspirated by the fan 3 and is divided into a primary airflow 14 and a secondary airflow 15, which circulate from upstream to downstream in the turbojet.

The primary airflow 14 flows through the turbojet 1 from upstream to downstream, passing in succession through the low-pressure compressor 7, the high-pressure compressor 10, the combustion chamber 6 where it is mixed with fuel to be burned, the high-pressure turbine 11 and the low pressure turbine 8. The passage of the primary airflow 14 through the high-pressure turbine 11 and the low-pressure turbine 8 causes rotation of the turbines 11 and 8 which in their turn drive in rotation the high pressure compressor 10 and the low-pressure compressor 7, as well as the fan 3, via the transmission shaft 9 and the transmission shaft 12.

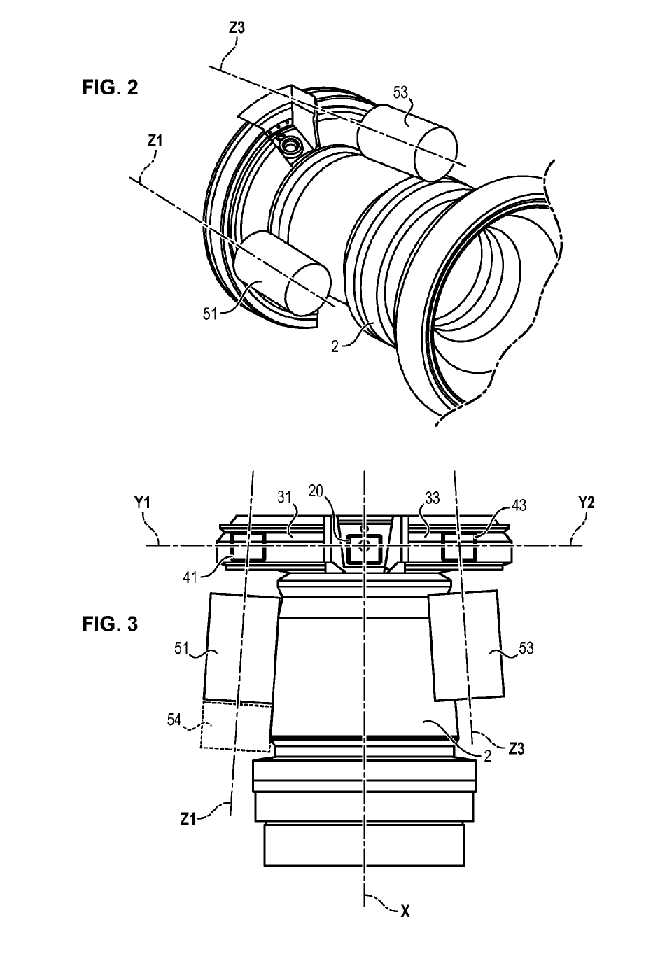

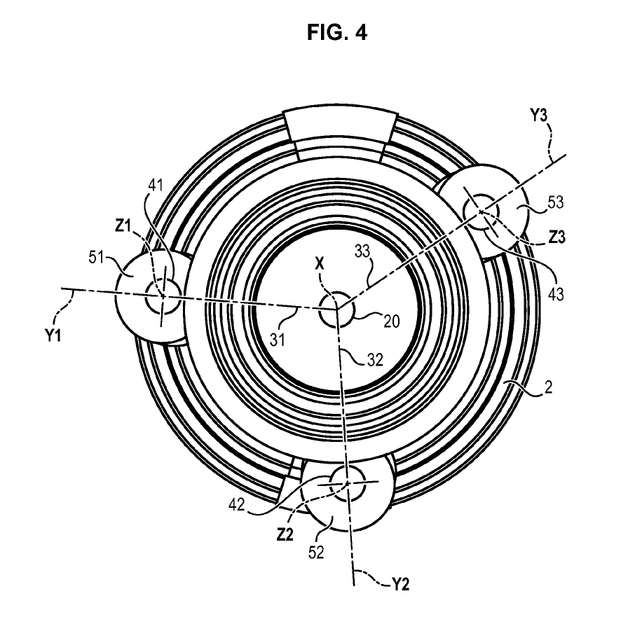

Moreover, as illustrated in FIGS. 1 to 4, the turbine engine 1 also comprises an accessory drive assembly comprising an inlet gearbox (IGB) 20, several radial drive shafts (RDS) 31 to 33, several transfer gearboxes (TGB) 41 to 43 and several pieces of auxiliary equipment 51 to 53.

The inlet gearbox 20 comprises an input bevel gear 22 and several output bevel gears 23. The input bevel gear 22 is attached to the high pressure transmission shaft 12. Each output bevel gear 23 is attached to one end of a respective radial drive shaft 31 to 33. The input bevel gear 22 meshes with each output bevel gear 23, thus forming an angle drive.

Each radial drive shaft 31 to 33 is housed inside a radial arm of the inter-compressor casing 16. Each radial drive shaft 31 to 33 is rotatably mounted around a respective axis of rotation Y1 to Y3 with respect to the inter-compressor casing 16. The axes of rotation Y1 to Y3 extend substantially perpendicularly to the axis X.

Thanks to the cooperation of the bevel gears 22 and 23, rotation of the high-pressure spool 5 around the axis X causes rotation of each radial drive shaft, 31 to 33 about its axis of rotation Y1 to Y3 with respect to the inter-compressor casing 16.

Each transfer gearbox 41 to 43 comprises an input bevel gear 45 and an output bevel gear 46. The bevel gears 45 and 46 can be housed inside the inter-compressor casing. The output bevel gear 46 meshes with the input bevel gear 45 forming an angle drive.

The transfer gearboxes 41 to 43 transmit the rotation movement of the radial drive shafts 31 to 33 respectively to the auxiliary equipment 51 to 53.

The auxiliary equipment 51 and 52 are for example accessories, while the auxiliary piece of equipment 53 is an accessory gearbox supporting other accessories.

The accessories 51 and 52 can comprise for example a fuel pump, an electrical generator, a lubricant pump, a hydraulic pump, a starter, a constant speed drive (CSD) or a tachometer.

Each accessory 51 and 52 comprises a stator attached to the inter compressor casing 16 and a rotor rotatably mounted with respect to the stator.

In each transfer gearbox 41 and 42, the input bevel gear 45 is attached to one end of the radial drive shaft 31, respectively 32, by means of splines for example, and the output bevel gear 46 is attached to the rotor of the accessory 51, respectively 52, by means of splines for example, so that rotation of the radial drive shaft 31, 32 drives rotation of the rotor of the accessories 51, 52 with respect to the stator.

In the transfer gearbox 43, the input bevel gear 45 is connected to one end of the radial drive shaft 33, and the output bevel gear 46 is attached to an input shaft of the accessory gearbox 53. The accessory gear box 53 comprises a box to which accessories can be attached and a gear train housed inside the box, the gear train transmitting the movement of the input shaft of the accessory gearbox 53 to different accessories supported by the accessory gearbox 53.

The pieces of equipment 51 to 53 are distributed around the engine casing 2 on the periphery thereof, being angularly spaced away from one another.

Moreover, the rotor of each accessory 51 and 52 has its axis of rotation Z1 and Z2 extending substantially parallel to an outer surface of the engine casing 2, in a substantially longitudinal direction of the turbine engine.

Likewise, the input shaft of the accessory gear box 53 has its axis of rotation Z3 extending substantially parallel to an outer surface of the engine casing 2, in a substantially longitudinal direction of the turbine engine.

This arrangement allows the space requirement of the drive assembly to be adapted to the space available in the zone located between the high-pressure spool and the inner fixed structure.

This arrangement also allows the masses of the accessories to be distributed around the axis X of the turbine engine, and to reduce the bulk of the accessory gearbox 53, which is not possible when all the accessories are connected to an accessory gearbox.

In addition, it can be provided that the auxiliary equipment 51 to 53 driven by the radial shafts are electrical generators supplying other equipment, such as hydraulic units or pumps, allowing this other equipment to be located in other zones of the turbine engine, remote from the generators.

As illustrated in FIG. 3, the accessory drive assembly can also comprise an additional accessory 54. The additional accessory 54 comprises a stator, attached to the inter-compressor casing or to the stator of the accessory 51, and a rotor rotatably mounted with respect to the stator. The rotor of the additional accessory 54 is connected to the rotor of the accessory 51, so that the rotor of the additional accessory 54 is driven in rotation via the rotor of the accessory 51, with or without a reduction/multiplication ratio. The rotor of the additional accessory 54 is driven in rotation around the axis of rotation Z1 or parallel to it. The accessory 51 and the additional accessory 54 are therefore driven in rotation around a common axis of rotation or around parallel axes of rotation.

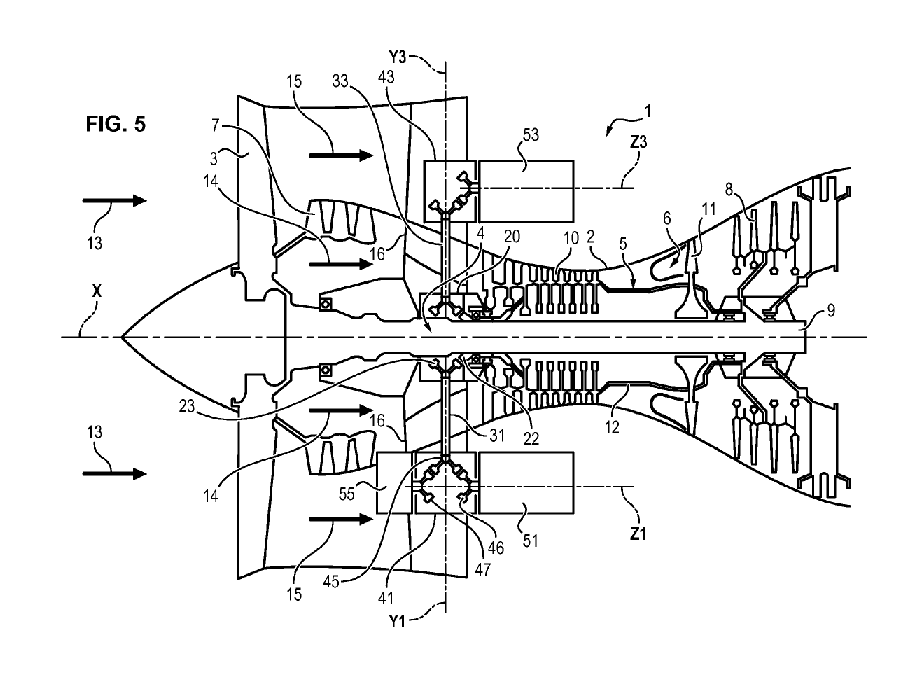

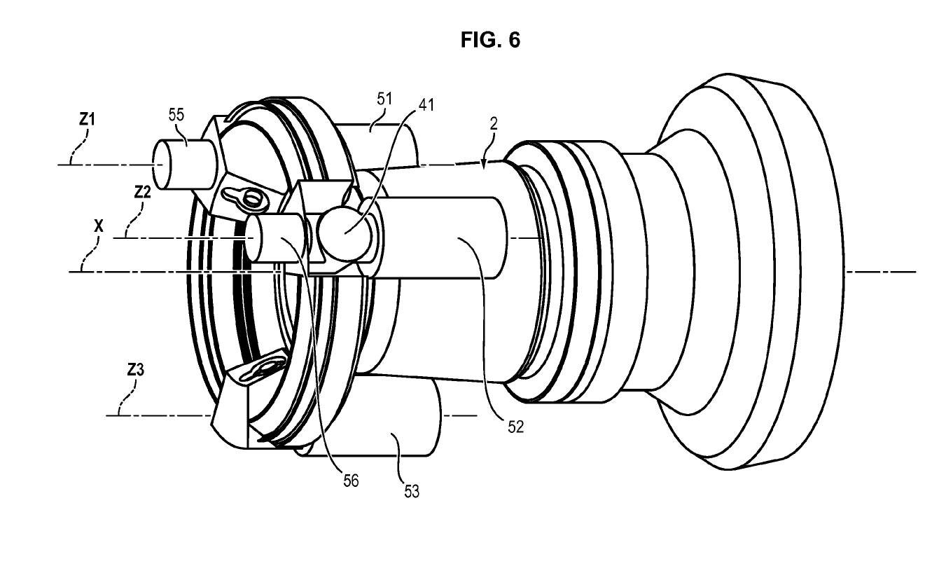

In FIG. 5, the turbine engine 1 shown is identical to the turbine engine of FIG. 1, except that it comprises an accessory drive assembly conforming to a second embodiment of the invention.

As illustrated in FIGS. 5 and 6, the accessory drive assembly comprises an inlet gearbox (IGB) 20, several radial drive shafts (RDS) 31 to 33, several transfer gearboxes (TGB) 41 to 43 and several pieces of auxiliary equipment 51 to 53, 55 and 56.

The inlet gearbox 20 and the radial drive shafts 31 to 33 are identical to those of the first embodiment.

On the other hand, in this second embodiment, each transfer gearbox 41 and 42 comprises an input bevel gear 45 and two output bevel gears 46 and 47. The bevel gears 45 to 47 can be housed inside the inter compressor casing 16. Each output bevel gear 46 and 47 meshes with the input bevel gear 45 by forming an angle drive.

As a variant, the transfer gearbox 41 or 42 can comprise a single output gear 46 attached to both the rotor of the accessory 51 and to the rotor of the accessory 55.

The transfer gearboxes 41 to 43 transmit the movement of rotation of the radial drive shafts 31 to 33 respectively to the pieces of auxiliary equipment 51 to 53, 55 and 56.

The pieces of auxiliary equipment 51 and 52 are for example accessories, while the piece of auxiliary equipment 53 is an accessory gearbox.

Each accessory 51, 52, 55 and 56 comprises a stator attached to the engine casing 2 or to the inter-compressor casing 16 and a rotor rotatably mounted with respect to the stator.

In each transfer gearbox 41 and 42, the input bevel gear 45 is attached to one end of the radial drive shaft 31, respectively 32. Each output bevel gear 46 is attached to the rotor of the accessories 51, respectively 52, so that rotation of the radial drive shaft 31, 32 drives rotation of the rotor of the accessory 51, 52 with respect to the stator. Likewise, each output bevel gear 47 is attached to the rotor of the accessory 55, respectively 56, so that rotation of the radial drive shaft 31, 32 drives rotation of the rotor of the accessory 55, 56 with respect to the stator.

In this manner, each transfer gearbox 41 and 42 drives two accessories 51 and 55 (respectively 52 and 56), the accessories being positioned on either side of the axis Y1 of the radial drive shaft 31 (respectively of the axis Y2 of the radial drive shaft 32).

In this configuration, the accessory 51 (respectively 52) is located in a zone of the turbine engine called the “core zone” (that is the zone situated between the primary airflow 14 and the secondary airflow 15), while the accessory 55 (respectively 56) is located in a zone of the turbine engine called the “fan zone” (zone located downstream of the core zone in the circulation direction of the air 13, prior to the division of the air 13 between the primary airflow 14 and the secondary airflow 15).

The rotor of each accessory 55 (respectively 56) has its axis of rotation coincident with the axis of rotation Z1 of the accessory 51 (respectively the axis of rotation Z2 of the accessory 52) connected to the same transfer gearbox 41 (respectively 42).

1. An aircraft turbine engine comprising an accessory drive assembly comprising:
a radial drive shaft,
an inlet gearbox comprising an input gear suitable to be attached to a transmission shaft connecting a turbine to a compressor of the turbine engine, and an output gear integral with the radial drive shaft,
a first accessory comprising a stator suitable to be attached to a casing of the turbine engine, and a rotor rotatably mounted with respect to the stator,
a transfer gearbox comprising an input gear integral in rotation with the radial drive shaft and an output gear integral in rotation with the rotor of the accessory, the input gear meshing with the output gear so that when the transmission shaft is driven in rotation, the transmission shaft drives the rotor of the accessory in rotation via the inlet gearbox, the radial drive shaft and the transfer gearbox,
wherein the first accessory is positioned in a first zone located between a primary airflow and a secondary airflow of the turbine engine, and the assembly comprises a second accessory or a piece of equipment positioned in a second zone located upstream of the first zone in the circulation direction of the airflows.

2. The turbine engine according to claim 1, wherein the input gear and the output gear of the transfer gearbox form an angle drive.

3. The turbine engine according to claim 1, wherein the transfer gearbox is designed to be housed in an inter-compressor casing of the turbine engine.

4. The turbine engine according to claim 1, wherein the first accessory is a fuel pump, an electrical generator, a lubricant pump, a hydraulic pump, a starter, a constant speed drive or a tachometer, or any other accessory necessary for the operation of the turbine engine or the aircraft.

5. The turbine engine according to claim 1, wherein the inlet gearbox comprises several output gears meshing with the input gear, and comprising several radial drive shafts and several pieces of equipment, each radial drive shaft connecting an output gear of the inlet gearbox with a respective piece of equipment to be driven, one of the pieces of equipment being the accessory.

6. The turbine engine according to claim 5, wherein one of the pieces of equipment is an accessory gearbox supporting one or more accessories.

7. The turbine engine according to claim 5, wherein the pieces of equipment are positioned around the casing of the turbine engine.

8. The turbine engine according to claim 1, comprising an additional accessory, the additional accessory comprising a stator attached to the casing of the turbine engine or to the stator of the accessory, and a rotor rotatably mounted with respect to the stator, the rotor of the additional accessory being connected to the rotor of the accessory, so that the rotor of the additional accessory is driven in rotation via the rotor of the accessory.

9. The turbine engine according to claim 1, comprising:
a turbine,
a compressor,
an engine shaft connecting the turbine to the compressor so that the turbine drives the compressor.

10. The turbine engine according to claim 9, comprising an engine casing in which are housed the turbine, the compressor and the transmission shaft, the accessory(ies) or piece(s) of equipment extending around the engine casing.
